(19) United States
(12) Patent Application Publication
(10) Pub. No.: US 2006/0000997 A1
(43) Pub. Date: Jan. 5, 2006

(54) Throttle device for internal combustion engine

(75) Inventors: Hiroki Shimada, Obu-city (JP); Hiroshi Tanimura, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/169,024

(22) Filed: Jun. 29, 2005

(30) Foreign Application Priority Data
Jun. 30, 2004 (JP) 2004-193916

(51) Int. Cl. F16K 1/22

(52) U.S. Cl. 251/308

(57) ABSTRACT

A throttle valve is rotatably disposed in an air passage formed in a throttle body. An amount of air supplied to an internal combustion engine is controlled by rotating the throttle valve. The throttle valve connected to a throttle shaft and the throttle body are formed at the same time by injecting molten resin into a molding die, in which a pair of bearing holders and the throttle shaft are set at predetermined positions. After the throttle body is taken out of the molding die, a pair of bearings are press-fitted into the bearing holders so that the throttle shaft is rotatably supported in the throttle body by the bearings. In this manner, deformation of the bearings in the molding process is avoided, and smooth rotation of the throttle valve is secured.

### CROSS-REFERENCE TO RELATED APPLICATION

This application is based upon and claims benefit of priority of Japanese Patent Application No. 2004-193916 filed on Jun. 30, 2004, the content of which is incorporated herein by reference.

### BACKGROUND OF THE INVENTION

1. Field of the Invention

The present invention relates to a throttle device for controlling an amount of air supplied to an internal combustion engine. A rotational angle of a throttle valve disposed in the throttle body is controlled by a motor which is driven according to operation of an acceleration pedal by a driver. The present invention also relates to a method of manufacturing such a throttle device.

2. Description of Related Art

A throttle device having a throttle valve driven by an electric motor that is controlled according to operation of an acceleration pedal by a driver has been known hitherto. A throttle body forming the throttle device is made of a resin material, as exemplified in JP-A-11-294203 and JP-A-2000-202866. As shown in FIG. 4 attached hereto, the resin-made throttle body 101 is molded together with a pair of bearing bushes 103, 104 that rotatably support a throttle shaft 102. The bearing bushes 103, 104 are held in shaft-supporting bosses 106, 107 of the throttle body 101. The throttle body 101 includes a cylindrical wall 105 forming an air passage therein.

In a molding process of the throttle body 101, the throttle shaft 102 and the bearing bushes 103, 104 are set at predetermined positions in a molding die, and then molten resin is injected into a cavity of the molding die. Then, the molten resin is further pressurized and maintained at that pressure for a while. Then, the molten resin is solidified by cooling the molding die. Thus, the throttle shaft 102 and the bearing bushes 103, 104 are molded together with the throttle body 101.

In the conventional throttle device, however, there has been a problem that the throttle shaft 102 does not smoothly rotate. This is because the bearing bushes 103, 104 may be deformed by a pressure of injection molding if the bearing bushes 103, 104 are not sufficiently strong, compared with the pressure of injection molding. The pair of bearing bushes 103, 104 may not be maintained at a coaxial relation due to shrinkage of the resin material after the injection molding. In addition, there has been a possibility that molten resin inters into a small gap between the throttle shaft 102 and the bearing bushes 103, 104 in the molding process. If this happens, smooth rotation of the throttle shaft 102 is prevented. In the case where an oil-impregnated sintered metal is used as the bearing bushes 103, 104, the impregnated oil may be permeated into the molten resin in the molding process. This results in decrease in mechanical strength of the resin-made throttle body.

DE 10105526 A1 also shows a throttle device in which bearings are directly insert-molded in a throttle body. JP-A-2003-522869 shows a resin throttle body in which a metallic member forming a cylindrical air passage and bearings for supporting a throttle shaft is insert-molded. It is not easy, however, to insert-mold the metallic member having a complex shape.

### SUMMARY OF THE INVENTION

The present invention has been made in view of the above-mentioned problems, and an object of the present invention is to provide an improved throttle device, in which bearings supporting a throttle shaft are press-fitted in bearing holders after the molding process is completed.

The throttle device is used for supplying air into an internal combustion engine in a controlled manner. The throttle device includes a throttle body, a throttle shaft rotatably supported in the throttle body and a throttle valve connected to the throttle shaft. A cylindrical air passage is formed in the throttle body made of a resin material. The throttle valve connected to the throttle shaft is rotated in the air passage, and thereby an amount of air passing through the air passage is controlled.

In manufacturing the throttle device, a pair of bearing holders are set in a molding die at predetermined positions in the molding die, and the throttle shaft is positioned in the molding die so that a predetermined space for inserting a bearing is formed between an inner bore of the bearing holder and the throttle shaft. Then, molten resin is injected into the cavity in the molding die, so that the throttle body and the throttle valve connected to the throttle shaft are formed at the same time. After the molten resin is solidified by cooling, the throttle body is taken out of the molding die. Then, each bearing is press-fitted into the inner bore of each bearing holder embedded in the throttle body, so that the throttle shaft is rotatably supported by the pair of bearings.

In order to secure coaxial relation between the bearing holders embedded in the throttle body and the throttle shaft, the throttle shaft may be positioned in the molding die at a position to compensate deformation of the throttle body in the molding process. The coaxial relation may be adjusted before press-fitting the bearings into the bearing holders by machining the bearing holders and/or the bearings, if necessary to secure smooth rotation of the throttle shaft.

According to the present invention, the bearings are press-fitted into the bearing holders after the molding process is completed. Therefore, deformation of the bearings by the molding pressure is avoided, and the molten resin is prevented from entering into a space between the inner bore of the bearings and the throttle shaft. Accordingly, smooth rotation of the throttle shaft is secured. In addition, the manufacturing process of the throttle device is simplified since the throttle body and the throttle valve connected to the throttle shaft are formed at the same time by injection molding.

Other objects and features of the present invention will become more readily apparent from a better understanding of the preferred embodiment described below with reference to the following drawings.

### BRIEF DESCRIPTION OF THE DRAWINGS

FIG. 1 is a cross-sectional view showing a throttle device of the present invention;

FIG. 2 is a cross-sectional view showing the throttle body, in which bearing holders are embedded and a throttle shaft is positioned in the bearing holders;

FIG. 3A is a cross-sectional view showing a position of a throttle shaft in the throttle body immediately after molding;

FIG. 3B is a cross-sectional view showing a position of the throttle shaft in the throttle body after a molding distortion is generated; and

FIG. 4 is a cross-sectional view showing a conventional throttle body in which bearing bushes are embedded.

### DETAILED DESCRIPTION OF THE PREFERRED EMBODIMENT

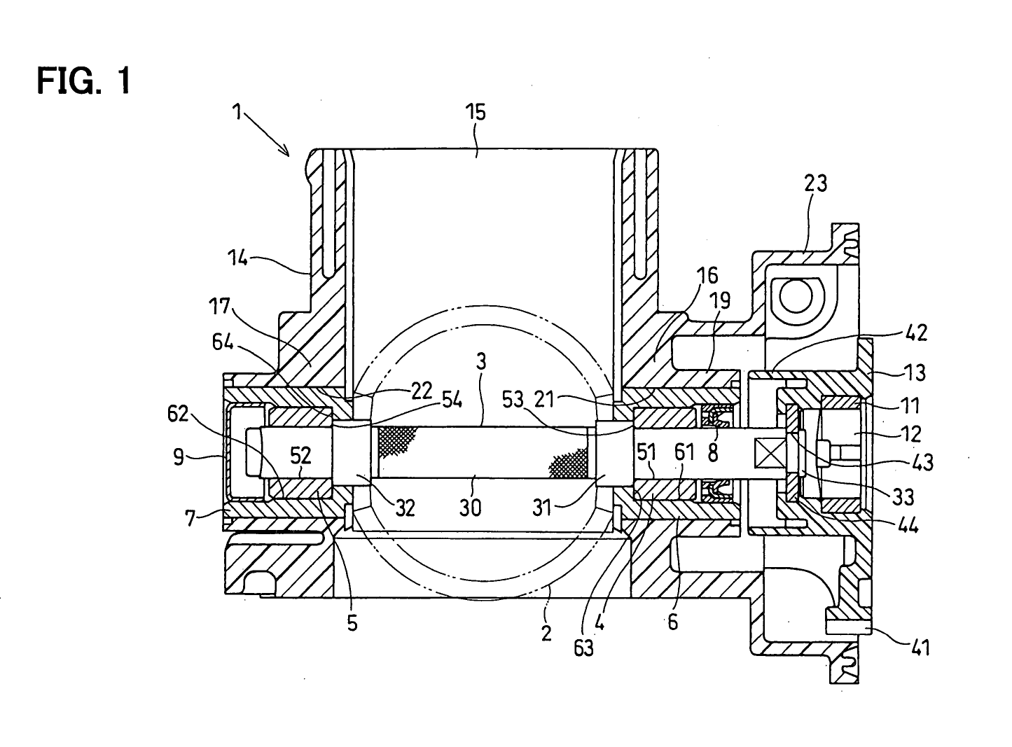

A preferred embodiment of the present invention will be described with reference to FIGS. 1, 2, 3A and 3B. First, referring to FIG. 1, an entire structure of a throttle device according to the present invention will be described. The throttle device is used for supplying air to an internal combustion engine in a controlled manner. The throttle device includes a throttle body 1 made of a thermoplastic resin material, a throttle valve 2 disposed in the throttle body 1, and a throttle shaft 3 supporting the throttle valve 2 thereon. The throttle shaft 3 is driven by a motor (not shown) which is in turn controlled by operation of an acceleration pedal by a driver. An angular position of the throttle valve 2 is fed-back to an electronic control unit (ECU).

An air passage 15 is formed in the throttle body 1, and the throttle valve 2 connected to the throttle shaft 3 is disposed in the air passage 15, so that an amount of air flowing through the air passage 15 is controlled according to an angular position of the throttle valve 2. The throttle shaft 3 is connected to an electric motor via a speed-reduction device and is driven by the motor in a direction for opening the air passage 15. The throttle shaft 3 is biased by a return spring in a direction to close the air passage 15. An angular position of the throttle valve 2 is detected by a throttle position sensor, and an electrical signal representing the angular position is fed to the electronic control unit. The electronic control unit drives the motor so that a difference between the signal representing the angular position of the throttle valve 2 and a signal representing an accelerator pedal position becomes minimal.

The throttle position sensor is connected to the right side axial end of the throttle shaft 3, and is composed of a member for generating a magnetic field and a sensor element (such as a Hall element, a Hall IC or a magneto-resistive element) for detecting changes in the magnetic field. The member for generating a magnetic field is composed of permanent magnets 11 and yoke 12 connected to an inner periphery of a valve gear 13 that constitutes the speed-reduction device.

The throttle body 1 is made of a thermoplastic resin material, such as polyphenylene sulfide (PPS), polyamide (PA), polypropylene (PP), polyether amide (PEI) and is formed by injection molding. The air passage 15 surrounded by a cylindrical wall 14 is formed in the throttle body 1. Air cleaned by an air cleaner is fed to the air passage 15 from an upside thereof and fed to each cylinder of an engine through a surge tank or an intake manifold connected to a bottom of the air passage 15.

In the throttle body 1, a pair of shaft-supporting bosses 16, 17 are formed so that their axial direction becomes perpendicular to an axial direction of the air passage 15. A pair of bearing holders 6, 7 are embedded in holes 21, 22 formed in the shaft-supporting bosses 16, 17. An outer circumference 19 of the shaft-supporting boss 16 (formed at the right side of the throttle body 1) functions as a spring guide for supporting an inner circumference of the return spring. At the right side end of the bearing holder 6, an oil seal 8 for liquid-tightly closing the opening of the bearing holder 6 is disposed. At the left side end of the bearing holder 7, a hermetic plug 9 for hermetically closing the opening of the bearing holder 7 is disposed.

A gear box 23 for containing the speed-reduction device therein is formed integrally with the cylindrical wall 14 at the right side of the shaft-supporting boss 16. A stopper for stopping the throttle valve 2 at its fully closed position is formed in the gear box 23. A stopper for stopping the throttle valve 2 at its fully open position may be formed in the gear box 23.

The throttle shaft 3 is composed of a connecting portion 30 to which the throttle valve 2 made of resin is connected by molding and a pair of end portions supported by a pair of bearings 4, 5 press-fitted in the bearing holders 6, 7. The throttle valve 2 is composed of a round disc portion having reinforcing ribs and a cylindrical portion. The cylindrical portion is connected to the throttle shaft 3 by molding. On the outer circumference of the connecting portion 30 of the throttle shaft 3, knurls are formed so that the cylindrical portion of the throttle valve 2 is firmly connected to the throttle shaft 3. Alternatively, the connecting portion 30 may be formed in a non-round cross-section having a pair of parallel surfaces to further improve connecting force between the throttle valve 2 and the throttle shaft 3. The throttle valve 2 rotates in the air passage 15 according to rotation of the throttle shaft 3, and thereby an amount of air passing through the air passage 15 is controlled.

The throttle shaft 3 further includes a pair of flanges 31, 32, each having a diameter larger than that of its end portion supported in the bearing 4, 5. Axial end surfaces of the flanges 31, 32 abut the axial ends of the respective bearings 4, 5, and thereby movement of the throttle shaft 3 in the axial direction is restricted.

The valve gear 13 constituting the speed-reduction device for transferring a motor torque to the throttle shaft 3 at a reduced speed is connected to the axial end of the throttle shaft 3 (at the right side end in FIG. 1). The valve gear 13 is made of a resin material or a metallic material and has gears 41 formed on its outer flange. The outer periphery 42 of the valve gear 13 functions as a spring guide for supporting an inner diameter of the return spring. A stopper for stopping the throttle valve 2 at its fully closed position is formed on the outer periphery of the valve gear 13. Another stopper for stopping the throttle valve 2 at its fully opened position may be formed on the outer periphery of the valve gear 13. Such stoppers may be directly formed on the inner circumference of the air passage 15.

A metallic disc 44 having a hole 43 is connected to the valve gear 13. When the valve gear 13 is formed by molding, the metallic disc 44 is insert-molded. An end 33 of the throttle shaft 3 is inserted into the hole 43 of the metallic disc 44 and staked to firmly connect the valve gear 13 to the throttle shaft 3. In order to connect the valve gear 13 to the throttle shaft 3 with a predetermined angular relative position, a pair of parallel surfaces to be coupled to the metallic disc 44 may be formed on the end 33 of the throttle shaft 3.

The bearings 4, 5 are made of a metallic material (such as brass, oil-less metal or copper) or a resin material and formed in a cylindrical shape. The bearings 4, 5 are press-fitted in the respective bearing holders 6, 7. The inner bores 51, 52 of the bearings 4, 5 rotatably support both ends of the throttle shaft 3, and a movement of the throttle shaft 3 in the axial direction is restricted by abutment between axial ends 53, 54 of the bearings 4, 5 and the flanges 31, 32 of the throttle shaft 3.

The bearing holders 6, 7, each having an inner bore 61, 62 and an axial inner end 63, 64, are insert-molded in holes 21, 22 of the shaft-supporting bosses 16, 17. Thus, the bearing holders 6, 7 are embedded in the throttle body 1. The bearings 4, 5 press-fitted in the bearing holders 6, 7 abut the axial inner ends 63, 64 of the bearing holders 6, 7, and thereby axial positions of the bearings 4, 5 are defined. An outer end of the inner bore 61 of the bearing holder 6 is enlarged, and an oil seal 8 is press-fitted in the enlarged portion to liquid-tightly close the outer end of the inner bore 61. Similarly, an outer end of the inner bore 62 of the bearing holder 7 is enlarged, and a hermetic plug 9 is press-fitted in the enlarged portion to hermetically close the outer end of the inner bore 62. The hermetic plug 9 not only prevents air leakage from the air passage 15 to the outside but also prevents outside dusts from entering into the air passage 15.

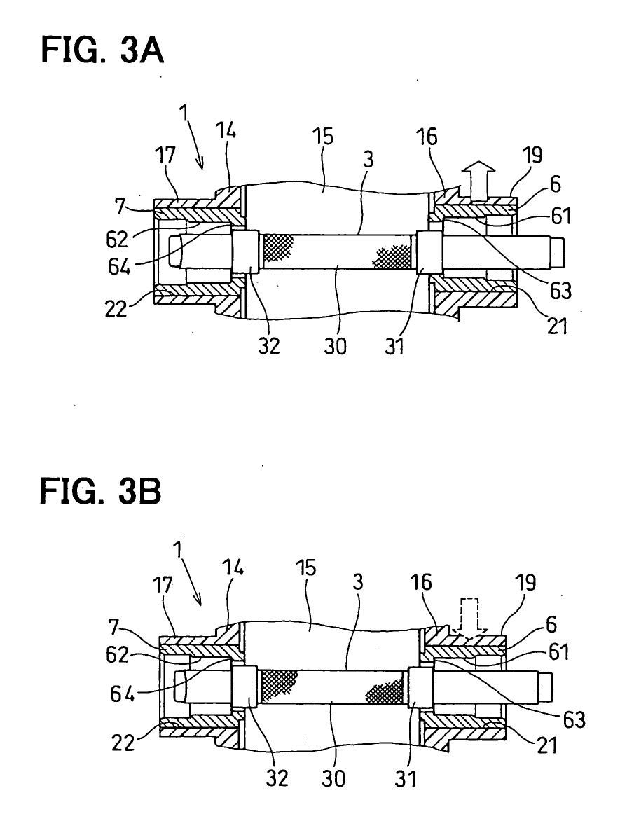

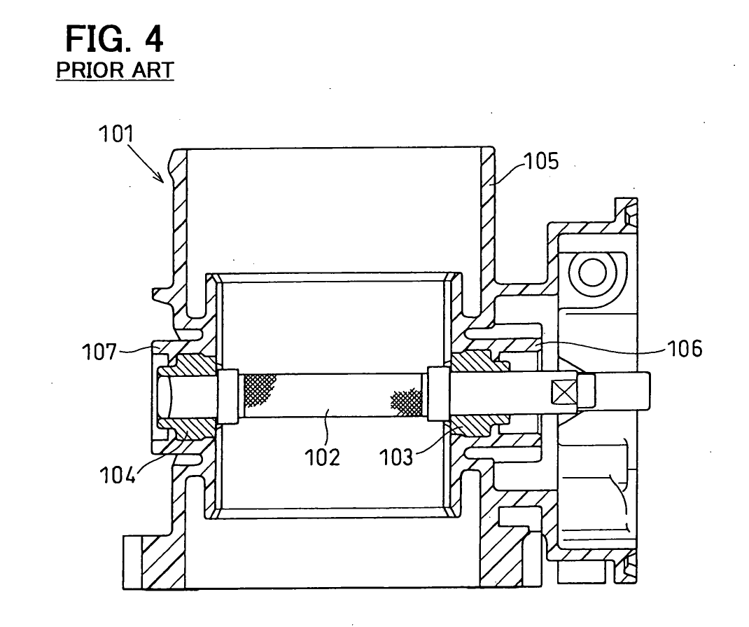

Now, a method of manufacturing the throttle device will be described with reference to FIGS. 1, 2, 3A and 3B. A molding die for molding the throttle body 1 by injection molding is composed of a stationary die and a movable die. First, the throttle shaft 3 and the bearing holders 6, 7 are placed in the molding die at predetermined respective positions. The throttle shaft 3 is placed in the bearing holders 6, 7 so that spaces for the bearings 4, 5 to be inserted after the molded throttle body 1 is solidified are secured. As shown in FIG. 3A, an axis of the throttle shaft 3 and an axis of either one of the bearing holders 6, 7 or both are placed to become a little off-centered (non-coaxial), considering a distortion in the molding process. In other words, the throttle shaft 3 and the bearing holders 6, 7 are placed in the molding die so that they become co-axial after completion of the injection molding process, as shown in FIG. 3B.

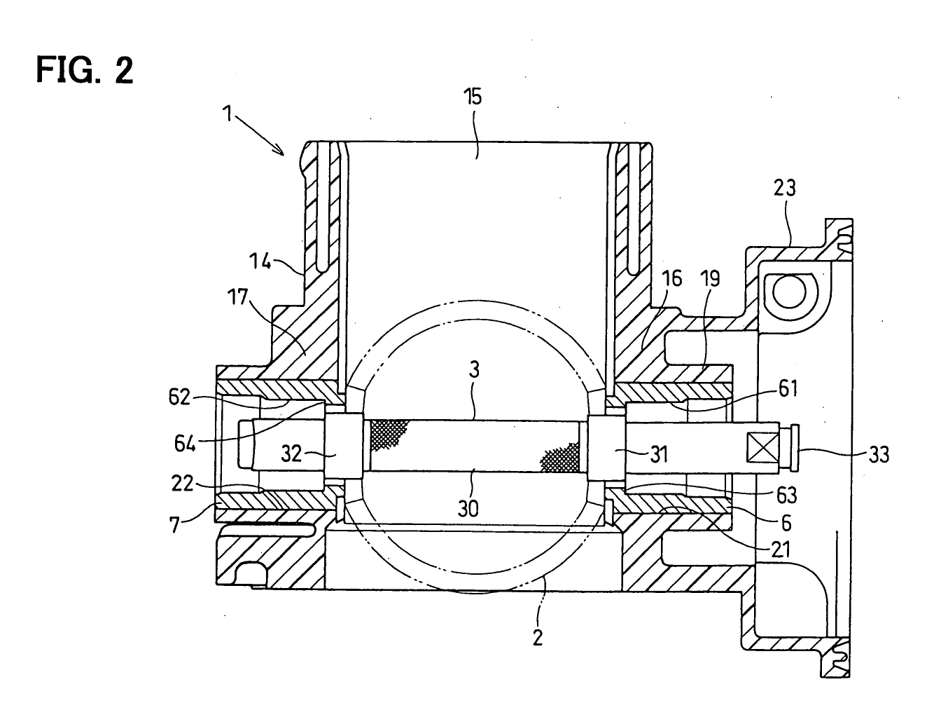

Then, molten resin (such as PPS, PBT resin) is injected into the cavity of the molding die to fill the cavity with the molten resin. Then, the injection pressure of the molten resin is gradually increased to a level higher than an original injection pressure, and the molten resin pressure is kept at the increased level for a while. In this manner, additional resin required due to shrinkage of the resin by cooling the molding die by supplying cooling water to passages in the molding die is fed to the cavity. Thus, the throttle body 1, in which the bearing holders 6, 7 are embedded and the throttle valve 2 is connected to the throttle shaft 3, is formed as shown in FIG. 2.

After the molded resin is solidified, the throttle body 1 is taken out of the molding die. Then, the throttle body 1 is further cooled down at a room temperature. At this stage, the throttle shaft 3 is loosely disposed in the bearing holders 6, 7 as shown in FIG. 2. Then, the bearings 4, 5 are press-fitted into the respective inner bores 61, 62 of the bearing holders 6, 7. At the same time, both ends of the throttle shaft 3 are supported in the bearings 4, 5. Thus, the throttle shaft 3 is rotatably supported in the throttle body 1. When the bearings 4, 5 are forcibly inserted into the bearing holders 6, 7, the bearing 4 is pushed until its axial end 53 abuts the axial inner end 63 of the bearing holder 6, and the bearing 5 is pushed until its axial end 54 abuts the axial inner end 64 of the bearing holder 7. In this manner, both bearings 4, 5 are correctly positioned in the throttle body 1 not to move in the axial direction.

Then, the hermetic plug 9 is forcibly inserted into the outer opening of the bearing holder 7 (at the left side of FIG. 1). Similarly, the oil seal 8 is inserted into the outer opening of the bearing holder 6 (at the right side).

As described above, the pair of bearing holders 6, 7 are integrally molded with the throttle body 1, and the throttle valve 2 is formed and connected to the throttle shaft 3 at the same time. Then, the pair of bearings 4, 5 are press-fitted into the bearing holders 6, 7 so that the throttle shaft 3 is rotatably supported in the throttle body 1. Therefore, the throttle body 1 having the throttle valve 2 is manufactured in a simple process, and thereby the throttle device can be manufactured at a low cost.

Now, operation of the throttle device will be briefly explained. Upon pressing the accelerator pedal, an electrical signal representing a position of the accelerator pedal is sent to the electronic control unit. The electronic control unit drives the motor so that the motor rotates the throttle shaft 3 by an angle corresponding to the electrical signal representing the position of the accelerator pedal. The throttle shaft 3 is rotated to a direction to open the throttle valve 2 against the biasing force of the return spring.

On the other hand, when the accelerator pedal returns to the original position, the throttle shaft 3 is rotated in a direction to close the throttle valve 3 by the biasing force of the return spring. The throttle valve 2 is rotated up to its fully closed position where the stopper members formed on the valve gear 13 and the gear box 23 abut each other. When the throttle valve 2 is at the fully closed position, an amount of air corresponding to an idling speed is supplied to the engine. Alternatively, the throttle shaft 3 may be driven by the motor in the direction to close the throttle valve 2 under the control of the electronic control unit. Thus, the opening degree of the throttle valve 2, i.e., the amount of air supplied to the engine is controlled according to operation of the acceleration pedal.

Advantages of the present invention will be summarized as follows. The bearing holders 6, 7 are integrally molded with the throttle body 1 by injection molding, and after the molded throttle body 1 is solidified, the bearings 4, 5 are press-fitted in the bearing holders 6, 7 to rotatably support the throttle shaft 3. Therefore, deformation of the bearings 4, 5 due to the pressure of the injection molding can be avoided. Further, it is avoided that molten resin enters into a clearance between the throttle shaft 3 and the bearings 4, 5 in the molding process. Thus, smooth rotation of the throttle shaft 3 is secured.

When the throttle shaft 3 and the bearing holders 6, 7 are set in the molding die, they are positioned in the die so that the throttle shaft 3 becomes co-axial with the bearing holders 6, 7 after the molding process is completed. In other words, they are positioned in the molding die, taking into consideration a small amount of positional displacement due to resin deformation in and after the molding process. In this manner, the rotational axis of the throttle shaft 3 and the bearing holders 6, 7 are kept in a co-axial relation.

The bearings 4, 5 and/or the inner bore of the bearing holders 6, 7 may be machined before press-fitting the bearings 4, 5 into the bearing holders 6, 7 if it is necessary to further secure the co-axial relation between the bearings 4, 5 and the throttle shaft 3. Clearance between the inner bores 61, 62 of the bearing holders 6, 7 and the outer circumference of the bearings 4, 5 may be a little enlarged to eliminate an adverse affect on the co-axial relation due to deformation of the bearing holders 6, 7 by the molding pressure.

The bearings 4, 5 are press-fitted into the bearing holders 6, 7 after the molding process of the throttle body 1 is completed. Therefore, if an oil-impregnated sintered metal is used as the bearings 4, 6, it is avoided that oil permeates into the molten resin to thereby decrease rigidity of the resin.

Movement of the throttle shaft 3 in the axial direction is restricted by abutment between the flanges 31, 32 and the axial ends 53, 54 of the bearings 4, 5. An axial position of the magnetic field (composed of the magnets 11 and yokes 12 connected to the valve gear 13 fixed to the throttle shaft 3) relative to the sensor element (carried on a sensor cover to face the magnetic field) is correctly kept. Therefore, the angular position of the throttle valve 2 is correctly detected by the sensor element. Further, the throttle valve 2 can be smoothly rotated in the air passage 15 without contacting the inner wall of the air passage 15 because the throttle shaft 3 is correctly and fixedly positioned in the axial direction.

The axial end of the throttle shaft 3 is closed by the hermetic plug 9, so that the air passage 15 does not communicates with the outside and the outside dusts are prevented from entering into the air passage 15. An amount of air passing through a gap between the throttle valve 2 and the inner wall of the air passage 15 when the throttle valve 2 is at the fully closed position is kept constant at a predetermined level. Therefore, an idling speed of the engine can be kept at a predetermined speed, and fuel consumption at the idling speed can be minimized.

The present invention is not limited to the embodiment described above, but it maybe variously modified. For example, the present invention may be applied to a throttle device that is not driven by an electric motor but directly driven by a wire connected to an accelerator pedal. Though the throttle valve 2 is made of resin and connected to the throttle shaft 3 by molding in the foregoing embodiment, it is also possible to mechanically connect a resin valve or a metallic valve to the throttle shaft 3 with screws or the like. Further, the throttle shaft 3 may be installed in the throttle body 1 after the throttle body 1 having the embedded bearing holders 6, 7 is formed by injection molding.

The cylindrical wall 14 forming the air passage 15 may be made as a double cylinder structure having a coaxial two cylindrical walls. A compound resin material having a filler material (such as glass fibers, carbon fibers, aramid fibers or boron fibers) may be used as the molding resin. For example, polybutylene telephthalate including 30% of glass fibers (PBTG30) may be used as the molding resin. The throttle body 1 having high strength and high rigidity as well as high heat resistivity can be manufactured by injection molding at a low cost, using a compound resin material.

In order to firmly embed the bearing holders 6, 7 in the throttle body 1, knurls, or small depressions and projections, may be formed on the outer circumference of the bearing holders 6, 7. Further, in order to prevent the bearing holders 6, 7 from being rotated in the holes 21, 22 of the shaft-supporting bosses 16, 17, two parallel surfaces may be formed on the outer circumference of the bearing holders 6, 7. Alternatively, the outer circumference of the bearing holders 6, 7 may be shaped in a polygonal surface.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A throttle device for controlling an amount of air supplied to an internal combustion engine, the throttle device comprising:
a throttle body having an air passage formed therein, the throttle body being made of a resin material;
a pair of bearing holders embedded in the throttle body by insert-molding;
a pair of bearings, each bearing being press-fitted in each bearing holder;
a throttle shaft rotatably supported by the bearings in the throttle body; and
a throttle valve connected to the throttle shaft so that an amount of air passing through the air passage is controlled according to rotation of the throttle shaft.

2. The throttle device as in claim 1, wherein: the bearing holders are components independent from the bearings and other components of the throttle device.

3. The throttle device as in claim 1, wherein:
the throttle device further includes a hermetic plug for hermetically closing an axial end of at least one of the bearing holders; and
the hermetic plug is press-fitted in the bearing holder.

4. The throttle device as in claim 1, wherein:
the bearing holders are made of a metallic material; and
the bearings are those selected from a group consisting of rolling bearings, sliding bearings, sintered metal bearings and resin-collar bearings.

5. A method of manufacturing a throttle device for controlling an amount of air supplied to an internal combustion engine, the throttle device including a throttle body having an air passage formed therein, a pair of bearing holders embedded in the throttle body, a pair of bearings held in the bearing holders, a throttle shaft rotatably supported by the bearings in the throttle body, and a throttle valve connected to the throttle shaft, the method comprising:
placing the pair of bearing holders in a molding die;
molding the throttle body by injecting a molten resin material into the molding die so that the bearing holders are embedded in the throttle body;
taking the throttle body out of the molding die after the resin material is solidified; and
press-fitting each bearing into each bearing holder.

6. The method manufacturing the throttle device as in claim 5, wherein:
in the placing step, the throttle shaft is disposed in the bearing holders at a predetermined position in the molding die; and
in the molding step, the throttle shaft is positioned in the bearing holders with a predetermined space apart therefrom, while the bearing holders are insert-molded in the throttle body.

7. The method of manufacturing the throttle device as in claim 6, wherein:
the molding die includes means for correctly adjusting a coaxial relation between the pair of bearing holders and the throttle shaft.

8. The method of manufacturing the throttle device as in claim 5, wherein:
the throttle device further includes a hermetic plug for hermetically closing an axial end of at least one of the bearing holders; and
the hermetic plug is press-fitted in the bearing holder after each bearing is press-fitted into each bearing holder.

9. The method of manufacturing the throttle device as in claim 5, wherein the method further includes a step for adjusting a coaxial relation between the pair of bearings and the throttle shaft.
